(19) United States
(12) Patent Application Publication
(10) Pub. No.: US 2012/0200538 A1
(43) Pub. Date: Aug. 9, 2012

(54) TOUCH SURFACE WITH TWO-DIMENSIONAL COMPENSATION

(75) Inventors: Tomas Christiansson, Torna-Hallestad (SE); Christer Fåhraeus, Bjarred (SE); Henrik Wall, Dalby (SE); Ola Wassvik, Brosarp (SE); Mattias Bryborn Krus, Lund (SE)

(73) Assignee: FLATFROG LABORATORIES AB, Lund (SE)

(21) Appl. No.: 13/502,649

(22) PCT Filed: Oct. 13, 2010
(86) PCT No.: PCT/SE2010/051105

§ 371 Date: Apr. 18, 2012

Related U.S. Application Data
(60) Provisional application No. 61/272,666, filed on Oct. 19, 2009.

(30) Foreign Application Priority Data
Oct. 19, 2009 (SE) 0950767-4

(51) Int. Cl. G06F 3/042

(52) U.S. Cl. 345/175

(57) ABSTRACT

An apparatus for determining an interaction between an object and a touch surface of a panel. An illumination arrangement introduces light into the panel for propagation by internal reflection between the touch surface and an opposite surface and towards a receiving light detection arrangement. A processor unit is configured to iteratively i) determine, based on the received light, a current light status representing a two-dimensional distribution of light in the panel, ii) determine the interaction with the object as a function of the current light status and a previously updated background status representing a two-dimensional distribution of light in the panel caused by contaminations, and iii) update the background status as a function of the interaction. A method and computer readable medium are also described.

### CROSS-REFERENCE TO RELATED APPLICATIONS

The present application claims the benefit of Swedish patent application No. 0950767-4, filed 19 Oct. 2009 and U.S. provisional application No. 61/272666, filed 19 Oct. 2009, both of which are incorporated herein by reference.

### TECHNICAL FIELD

The invention relates to techniques for detecting the interaction between an object and a touch surface. The touch surface may be part of a touch-sensitive panel.

### BACKGROUND ART

To an increasing extent, touch-sensitive panels are being used for providing input data to computers, cell phones, electronic measurement and test equipment, gaming devices, etc. The panel may be provided with a graphical user interface (GUI) for a user to interact with using e.g. a pointer, stylus or one or more fingers. The GUI may be fixed or dynamic. A fixed GUI may e.g. be in the form of printed matter placed over, under or inside the panel. A dynamic GUI can be provided by a display screen integrated with, or placed underneath, the panel or by an image being projected onto the panel by a projector.

There are numerous known techniques for providing touch sensitivity to the panel for purpose of detecting interaction between a touching object and the panel, e.g. by using cameras to capture light scattered off the point(s) of touch on the panel, or by incorporating resistive wire grids, capacitive sensors, strain gauges, etc. into the panel.

U.S. Pat. No. 7,432,893 discloses an alternative technique which is based on frustrated total internal reflection (FTIR). Diverging beams from two spaced-apart light sources is coupled into a panel to propagate inside the panel by total internal reflection. The light from each light source is evenly distributed throughout the entire panel. Arrays of light sensors are located around the perimeter of the panel to detect the light from the light sources. When an object comes into contact with a surface of the panel, the light will be locally attenuated at the point of touch. The interaction between the object and the panel is determined by triangulation based on the attenuation of the light from each source at the array of light sensors.

U.S. Pat. No. 3,673,327 discloses a similar technique also using FTIR in which arrays of light beam transmitters are placed along two edges of a panel to set up a grid of intersecting light beams that propagate through the panel by internal reflection. Corresponding arrays of beam detectors are placed at the opposite edges of the panel. When an object touches a surface of the panel, the beams that intersect at the point of touch will be attenuated. The attenuated beams on the arrays of detectors directly identify the interaction between the object and the panel.

US2009/0153519 discloses another technique also using FTIR where a tomograph includes signal flow ports that are positioned at discrete locations around a border of a touch-panel. Signals are introduced into the panel to pass from each discrete panel-border location to a number of other discrete panel-border locations. The passed signals are tomographically processed to determine if any change occurred to the signals is caused by a touch on the panel during signal passage through the panel. From the tomographically processed signals any local area on the panel where a change occurred is determined. The tomograph thereafter computes and outputs a signal indicative of a panel touch and location.

The FTIR techniques described above are generally capable of identifying touches but suffer from an inability to satisfactory differentiate relevant objects touching the panel from contaminations possibly present on the panel. Examples of contaminations that may appear on the touch surface are, for example, fingerprints, dirt, fluids and scratches.

### SUMMARY

It is an object of the invention to at least partly overcome one or more of the above-identified limitations of the prior art. In particular, it is an object to provide a touch-sensitive apparatus that determines an interaction between a relevant object and a touch surface of the apparatus, while still avoiding interpreting a contamination as a user-interaction.

Hence an apparatus is provided for determining an interaction between an object and a touch surface, the apparatus comprising: a light transmissive panel defining the touch surface and an opposite surface; an illumination arrangement configured to introduce light into the panel for propagation by internal reflection between the touch surface and the opposite surface; a light detection arrangement configured to receive the light propagating in the panel; and a processor unit. The processor unit is configured to iteratively i) determine, based on the received light, a current light status representing a current two-dimensional distribution of light in the panel, ii) determine, when the object touches the touch surface and thereby attenuates the light propagating in the panel, the interaction as a function of the current light status and a previously updated background status representing a two-dimensional distribution of light in the panel caused by contaminations, and iii) update the background status as a function of the interaction.

Updating the background status as a function of the interaction can be done in various ways, as described below, and basically means that an interaction is taken into account when the background status is updated. This represents one major difference from prior art, which updates e.g. a so called “background level” with no regard to an interaction. Accordingly, prior art produces the same “background level” for different interactions while the apparatus herein can produce a background status that is different for different interactions. Therefore, it is true that the processor unit of the apparatus may be configured to update the background status as a function of the interaction, such that the background status can be different for different interactions. When e.g. used for determining interactions the background status provides, in comparison with a conventional “background level”, more accurate determination of interactions.

The interaction between the object, such as a stylus or a finger, and the touch surface is typically caused by the object touching the touch surface. The interaction can define the location of the object on the touch surface and/or the area of the touch surface that is in contact with the object at the interaction. The interaction can also define the shape of the interaction, and may be referred to as a touch.

The propagation by internal reflection between the touch surface and the opposite surface has typically the form of total internal reflection, and the attenuation of the light when the object touches the touch surface generally involves FTIR.

It should be noted that several suitable techniques for introducing light in the panel as well as techniques for receiving the light exist, which includes a possibility to introduce and receive the light at a number of different light incoupling sites and light outcoupling sites at e.g. an edge of the panel or at an upper or at a lower surface of the panel.

In a broad sense, the current light status may be seen to represent the two-dimensional distribution of light in the panel, i.e. the spatial distribution of light between the touch-surface and the opposite surface, caused by both relevant user interactions and contaminations. For example, the current light status may be a set of data describing any one of an attenuation of light in the panel, a general transmission of light through the panel, the intensity of light in the panel, or any other parameter associated with the distribution of light in the panel. Also, since interactions and contaminations generally cause an attenuation of light at or across the touch surface, it may be said the current light status represents the two-dimensional distribution of light across the touch surface.

In any case, the current light status indicates locations where the light propagating in the panel is affected by an object touching the touch-surface. The denomination “current” is here intended to indicate a light status during the current iteration performed by the processor unit, but can in a more general aspect be seen as the light status used for determining the current interaction(s) between object and touch-surface. The current light status may be generated by applying some kind of reconstruction algorithm on raw-data obtained by the light detection arrangement. As is known within the art, generating a two-dimensional distribution of light per se can be done in numerous ways and hence any suitable technique may be applied.

The background status representing a two-dimensional distribution of light in the panel caused by contaminations is preferably represented by the same type of data as the current light status and may be reconstructed by using the same technique as for the reconstruction of the current light status.

The background status must however not at every moment represent the very exact two-dimensional distribution of light caused by, or associated with, contaminations on or in the panel but may be an estimation thereof. Also, the background status must not be updated during each iteration performed by the processor unit, even though this is possible. Here, contaminations typically cause “false” interactions while objects placed on the touch surface for providing user interaction cause “true” interactions.

By (intermittently) updating the background status, status features originating from contaminations can be automatically suppressed or even eliminated when determining the interaction between the object and the touch panel. This is advantageous in that a reduced impact of contaminations on the touch screen is achieved when determining interactions, such that only interactions with “true” objects like fingers or styluses are determined.

Moreover, the apparatus is particularly suitable when the determining of the interaction is based on attenuation of light and the potentially complex distribution of light received by the light detection arrangement. In particular, in case the internal reflections in the panel are caused by total internal reflection (TIR) and the touch of the object causes FTIR, the apparatus has been found surprisingly promising in respect of efficiently determining the interaction while still employing comparatively simple and efficient data processing.

The processor unit may be configured to update the background status when the object is present on the touch surface. This must not necessarily mean that the updating is triggered by an interaction caused by the object, even though this is possible, but rather that the updating of the background status is performed regardless of a presence of the object. Updating the background in this manner is in sharp contrast to e.g. known techniques attempting to take contaminations due to manufacturing defects into account when determining the interaction. Also, known techniques often use a static reference “background” determined when finalizing the assembly of the touch-sensitive panel.

The processor unit may be configured to update a first section of the background status corresponding to the interaction different from a second section of the background status not corresponding to the interaction.

Here, a section (i.e. a part) of the background status corresponding to the interaction can also be interpreted as a section “indicating” or “spatially defining” the interaction. The different updating of two sections of the background status can, for example, comprise updating one of the sections while the other section is not updated, updating the sections at different time intervals, using different calculations for the updating of the respective section etc.

The processor unit may be configured to refrain from updating a first section of the background status corresponding to the interaction while updating a second section of the background status not corresponding to the interaction. Generally, the second section does not correspond to any other interaction. This is typically advantageous when it is desired to quickly take contaminations such as fingerprints into account when determining a number of simultaneous and/or subsequent interactions, since e.g. attenuation caused by a true object may otherwise be included in the background status, which may case problems when determining interactions in subsequent iterations.

The processor unit may be configured to update a first section of the background status corresponding to the interaction by setting a value of the first section as a function of a value of a spatially corresponding section of a previous background status. For example, a part of the background status can be set to a spatially corresponding part of an earlier background status.

Employing this operation can, depending on how the background status is updated, be advantageous in that it is possible to set the background status right, for example if a section of the background status spatially corresponding to the interaction has been updated on basis of light received by the light detection arrangement after the interaction was initiated. This allows a background status to be updated without taking the effect of an interacting, true object into account.

The processor unit may be configured to update a first section of the background status corresponding to the interaction faster than a second section of the background status not corresponding to the interaction, when the interaction between the object and the touch surface has disappeared.

Updating faster comprises updating more frequently as well as e.g. applying a relatively higher weight factor to a more recently derived background status than to an older background status, which statuses in combination are used for determining the updated background status. This means that a section of the background status that previously spatially corresponded to an interaction can be updated faster than other sections of the background signal previously not corresponding to the same interaction. After a certain number of updating iterations from when the interaction disappeared, the first section may be updated at same time intervals or by applying a same weight factor as for other sections of the background status.

Updating in this manner is advantageous in that a “false” interaction or “false” touch, such as an interaction caused by a fingerprint remaining on the location of previous interaction, can be included in the background status relatively fast.

The processor unit may be configured to update the background status at predetermined time intervals, which time intervals may be established as a function of interactions with the touch surface. By using certain, predetermined time intervals, which can have same or different values, the background status can by coincidence be updated e.g. when an object interacts with the touch surface. A time interval of the time intervals can be dynamic, such as temporarily decreased when a relatively large number of interactions are present on the touch surface. In a corresponding manner the time interval can be increased when a relatively small number of objects interact with the touch surface. The time interval can be e.g. every four seconds, each iteration or every 10:th iteration performed by the processor unit, and can be different at interaction indicating and non-interaction indicating sections.

The processor unit may be configured to reconstruct the current light status and the background status on basis of light received by the light detection arrangement. The reconstruction typically generates, on basis of a raw-signal of the light detection arrangement, a representation of the two-dimensional distribution of light for the current light status. In a similar manner the reconstruction can for the background status generate a representation of the two-dimensional distribution of light caused by contaminations. The two-dimensional distributions may, depending on data format used for the representations, generally be plotted in a respective three-dimensional graph where the level of intensity/energy of light/attenuation etc. is given in two-dimensions on the touch surface. The generation of the two-dimensional distributions of light can be achieved by using numerous, known techniques, such as triangulation based techniques, tomography based techniques etc. using a raw signal of the light detection arrangement (or a signal derived there from) as input.

The processor unit may be configured to determine, when the object touches the touch surface and thereby attenuates the light propagating in the panel, the interaction in dependence of a time-distributed (temporal) variation of light received by the light detection arrangement.

This includes determining the interaction in dependence of any signal or set of data derived from the time-distributed variation of light received by the light detection arrangement. Generally, the variation of light can indicate whether an interaction is caused by a touch of a true object, for example if the time-distributed variation has a certain slope over the time or if it has a certain ripple, which is based on the understanding that a true object generally appears and disappears relatively quick and is rarely held completely still. Determining an interaction in this manner can be advantageous in that true interactions may be even more efficiently differentiated from false interactions.

The processor unit may be configured to determine, when the object touches the touch surface and thereby attenuates the light propagating in the panel, the interaction in dependence of a time passed since the interaction was determined. For example, if an interaction is present on the touch surface for a long time such as 3 minutes or more, it is unlikely that the interaction is caused by a true object, and the interaction can then be determined to be an invalid interaction caused by a false object. This determination is based on the understanding that contaminations generally are present on the touch surface for a much longer time than true-objects, and is advantageous since it is possible to update the background status in dependence of a true interaction, a disappearance of a true interaction, a false interaction etc.

The processor unit may be configured to determine a touch status of the panel, where the touch status defines the spatial distribution of a number of objects currently present on the touch surface. Accordingly, the touch status can be seen as a map over the touch surface where true interactions are indicated.

The processor unit may be configured to update the background status as a function of the touch status, which has proven to be a convenient implementation for efficiently taking all true interactions into account when determining the background status.

The touch status may comprise data elements, where each data element corresponds to a respective image pixel of the panel, which e.g. facilitates various data processing and filtering operations performed in connection with the identification of true interactions.

The data elements may be configured to indicate the interaction between the object and the touch surface, and the processor unit may be configured to spatially filter the data elements. More particularly, the processor unit may be configured to morphologically filter the data elements such that e.g. signal noise may be removed and/or for allowing the touch status to even more reliably indicate true interactions.

The processor unit may be configured to compare a value of the background status with a value of the current light status, when determining the interaction. The comparison can, for example, comprise subtracting a value of the background status from a value of the current light status. The result from the subtraction may then be investigated for determining the interaction. The comparison can also comprise investigating whether the current light status is larger or smaller than the background status, possibly in combination with using a threshold value applied on any of the current light status and the background status.

The comparing operation is particularly suitable when the background status and current light status are represented in the form of attenuation, since relatively little computational effort is required by the processor unit. Also, a light status compared with a background status may greatly facilitate the identification of relevant profile changes indicative of interactions caused by true objects.

However, optional or additional operations may be used when determining the interaction. For example, the processor unit may be configured to divide a value of the current light status with a value of the background status, when determining the interaction. The result from the division can be seen as a compensated light status which can have an essentially uniform signal level with a local decline or, depending on representation, increase in the compensated light status at the location of the interaction.

Also, when determining the interaction the processor unit may be configured to subtract a logarithm of a value of the background status from a logarithm of a value of the current light status. In this case the logarithm of the compensated light status described above can be determined, and the same effect as the above described operation of dividing is achieved but at a reduced computational cost. Also, the determining of a logarithm of a certain value can be based on looking up the value and its logarithm in a table, which further reduces the computational cost.

The illumination arrangement may comprise a set of light emitters for introducing the light and the light detection arrangement may comprise a set of light detectors for receiving the light, where the current two-dimensional distribution of light represented by the current light status and the two-dimensional distribution of light caused by contaminations and represented by the updated background status are each introduced and received by the same sets of light emitters and light detectors. Here, the “set of” detectors/emitters may include one or more pairs of detectors/emitters.

According to another aspect of the invention a method in an apparatus is provided for determining an interaction between an object and a touch surface of a light transmissive panel defining the touch surface and an opposite surface. The method comprises the steps of: introducing light into the panel for propagation by internal reflection between the touch surface and the opposite surface; receiving the light propagating in the panel; and iteratively i) determining, based on the received light, a current light status representing a current two-dimensional distribution of light in the panel, ii) determining, when the object touches the touch surface and thereby attenuates the light propagating in the panel, the interaction as a function of the current light status and a previously updated background status representing a two-dimensional distribution of light in the panel caused by contaminations, and iii) updating the background status as a function of the interaction.

According to another aspect, a method as described above is provided, with the difference that the steps of introducing and receiving light is omitted. In this case the method may be implemented in the form of processing instructions that may be downloaded into a memory of e.g. a touch apparatus, which then can use the instructions for updating the background status as a function of the interaction.

The inventive methods may include any of the functionality implemented by the features described above in association with the inventive apparatus and share the corresponding advantages. For example, each of the methods may include a number of steps corresponding to the above described operations of the processor unit.

Moreover, according to a further aspect of the invention a computer-readable medium is provided, which stores processing instructions that, when executed by a processor, performs the above described method.

Still other objectives, features, aspects and advantages of the invention will appear from the following detailed description, from the attached claims as well as from the drawings.

### BRIEF DESCRIPTION OF THE DRAWINGS

Embodiments of the invention will now be described, by way of example, with reference to the accompanying schematic drawings, in which

FIG. 1 is a top plan view of an embodiment of a touch-sensing apparatus for determining a location of at least one object on a touch surface,

FIG. 2 is a cross sectional view of the apparatus in FIG. 1,

FIG. 3 is a flow diagram illustrating an embodiment of a method for determining a location of at least one object on a touch surface, performed by the apparatus of FIG. 1,

FIG. 4a illustrates a background status representing a two-dimensional distribution of light in the apparatus in FIG. 1 caused by contaminations,

FIG. 4b illustrates a current light status representing a two-dimensional distribution of light in the apparatus in FIG. 1 during interaction with an object,

FIG. 4c illustrates a compensated light status for indicating true interactions on the apparatus of FIG. 1,

FIG. 5a illustrates a touch status corresponding to the compensated light status of FIG. 4c,

FIG. 5b illustrates the touch status of FIG. 5a after being spatially filtered,

FIG. 5c illustrates an enlarged, partial view of the touch status of FIG. 5b,

FIG. 6 illustrates a time-distribution of the current light status at a point indicative of an interaction with an object, a time-distributed background status at the same point and threshold levels for the current light status and background status,

FIG. 7 illustrates certain parameters of the time-distribution of the current light status of FIG. 6,

FIGS. 8a-8d illustrate a background status, current light status, compensated light status and touch status obtained when multiple interactions with objects are present on the apparatus in FIG. 1, and

FIGS. 9a-9c illustrate time-distribution of a current light status, a background status and a compensated light status, in accordance with some principles described herein.

### DETAILED DESCRIPTION

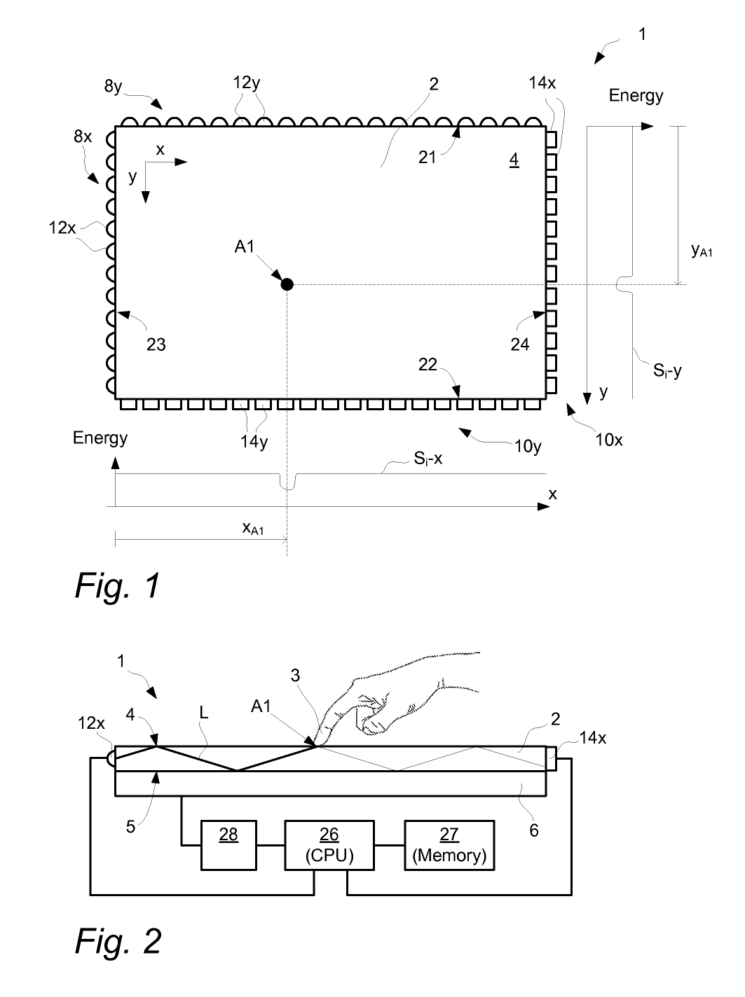

With reference to FIG. 1 and FIG. 2, an embodiment of touch-sensing apparatus 1 for determining an interaction A1 between an object 3 that touches a touch surface 4 is illustrated. The touch-sensing apparatus 1 includes a light transmissive panel 2 that may be planar or curved. The panel 2 defines the touch surface 4 and an opposite surface 5 opposite and generally parallel with the touch surface 4. The panel 2 is configured to allow light L to propagate inside the panel 2 by internal reflection between the touch surface 4 and the opposite surface 5.

In FIG. 1, a Cartesian coordinate system has been introduced, with the x-axis being parallel to a first side 21 and to a second side 22 of the panel 2 while the y-axis is parallel to a third side 23 and to a fourth side 24 of the panel 2. The exemplified panel 2 has a rectangular shape but may just as well be e.g. circular, elliptical or triangular, and another coordinate system such as a polar, elliptic or parabolic coordinate system may be used for describing the interaction A1 and various directions in the panel 2.

Generally, the panel 2 may be made of any material that transmits a sufficient amount of light in the relevant wavelength range to permit a sensible measurement of transmitted energy. Such material includes glass and polycarbonates. The panel 2 is typically defined by a circumferential edge portion such as by the sides 21-24, which may or may not be perpendicular to the top and bottom surfaces 4, 5.

The light L may be coupled into the panel 2 via one or more incoupling sites on the panel 2. For example and as shown in FIG. 1, the light L may be coupled into (be introduced into) the panel 2 via a first incoupling site 8x at the third side 23 of the panel 2 and via a second incoupling site 8y at the first side 21 of the panel 2. A first illumination arrangement 12x is arranged at the first incoupling site 8x and introduces the light L such that the light propagates in the x-direction. A second illumination arrangement 12y is arranged at the second incoupling site 8y and introduces light such that light propagates in the y-direction.

The light L propagated in the x-direction is coupled out via (received at) a first outcoupling site 10x at the fourth side 24 of the panel 2 while the light propagated in the y-direction is coupled out via a second outcoupling site 10y at the second side 22 of the panel 2. A first light detection arrangement 14x is arranged at the first outcoupling site 10x and a second light detection arrangement 14y is arranged at the second outcoupling site 10y, and can each measure the energy of the light at the respective outcoupling site 10x, 10y.

Each of the illumination arrangements 12x, 12y has a respective set of light emitters while each of the light detection arrangement 14x, 14y has a respective set of light detectors. Each of the light emitters emits light in the form of a beam that is received by an opposite detector of the detectors, such that the full panel 2 is illuminated. Hence, the light introduced at the incoupling sites 8x, 8y creates sheets of light in a respective of the directions x and y, while light is detected at the outcoupling sites 10x, 10y at different spatial locations along the length of the respective outcoupling site 10x, 10y. It is also possible to create and use additional sheets of light along other directions than the directions x and y.

As mentioned, the light L is allowed to propagate inside the panel 2 by internal reflection between the touch surface 4 and the opposite surface 5. As is known within the field of touch-sensitive panels, the internal reflection is typically caused by total internal reflection (TIR) which is sustained as long as the light L is injected into the panel at an angle to the normal of the panel which is larger than the critical angle at a light-injection site of the panel.

When the propagating light L impinges on the touch surface 4, the touch surface 4 allows the light L to interact with the touching object 3, and at the interaction A1, part of the light L may be scattered by the object 3, part of the light L may be absorbed by the object 3 and part of the light L may continue to propagate unaffected. The scattering and the absorption of light are in combination referred to as attenuation. The interaction A1 between the touching object 3 and the touch surface 4 is typically defined by the area of contact between the object 3 and the touch surface 4, and results in the mentioned interaction between the object 3 and the propagating light L. The interaction between the object 3 and the light L generally involves so-called frustrated total internal reflection (FTIR), in which energy of the light L is dissipated into the object 3 from an evanescent wave formed by the propagating light L, provided that the object 3 has a higher refractive index than the material surrounding the touch surface 4 and is placed within less than several wavelengths distance from the touch surface 4.

The interaction A1 can be defined by the area of contact between the object 3 and the touch surface 4 and/or by its location on the touch surface 4.

By using the light detection arrangements 14x, 14y for measuring the energy of the light L at different spatial locations along the length of the respective outcoupling site 10x, 10y, the location A1, i.e. the “touch location”, may be determined as will be described in detail below.

More particularly, in FIG. 1 the object 3 is placed on the panel 2, and measurement signal profiles Sᵢ-x, Sᵢ-y are generated by the light detection arrangements 14y, 14x. The signal profiles Sᵢ-x, Sᵢ-y represent the measured energy of light at the outcoupling sites 10y, 10x of the panel 2 during a sensing instance no. i. The signal profiles Sᵢ-x, Sᵢ-y indicate measured energy as a function of time and/or x-y position in the given coordinate system. A sensing instance can be e.g. a short period of time during which data representing the signal profiles Sᵢ-x, Sᵢ-y can be retrieved.

As shown, the touching object 3 causes a local decrease in signal profile Sᵢ-x at a location along the x-axis corresponding to the x-coordinate x_{A1} of the interaction A1. In a similar manner, the object 3 causes a local decrease in Sᵢ-y at a location along the y-axis corresponding to the y-coordinate y_{A1} of the interaction A1. The extent of the respective signal decrease depends on the area of interaction between the object 3 and the touch surface 4, and the amplitude of the decrease depends on the attenuation caused by the object 3. Accordingly, the object 3 is attributed to signal features which depend on the apparent size of the object 3, where a signal feature depends on the absorptive/scattering properties of the object 3 as well as the size of the object. The same attributes also apply to any contamination such as a fingerprint, fluid, dust, scratch etc. present on the touch surface 4.

By using a number of signal profiles like Sᵢ-x, Sᵢ-y derived during a number of n subsequent sensing instances, where i={1, . . . , n}, a processor unit (CPU) 26 can, as will be described in more detail below, perform a method for continuously determining a current light status Cᵢ, determining a touch (interaction) status TSⱼ, determining a background status Bₖ and determining and outputting the interaction A1. For this purpose a memory unit 27, i.e. a computer-readable medium, is connected to the processor unit 26 and is used for storing processing instructions that, when executed by the processor unit 26, performs the method.

For receiving signal profiles like Sᵢ-x, Sᵢ-y, or more specifically, data corresponding to the signal profiles Sᵢ-x, Sᵢ-y, the processor unit 26 is connected to the light detection arrangements 14x, 14y such that the signal profiles Sᵢ-x, Sᵢ-y can be retrieved by the processor unit 26. Also, the processor unit 26 is connected to the illumination arrangements 12x, 12y for initiating and controlling the introduction of light L in the panel 2.

The apparatus 1 can also include an interface device 6 for providing a graphical user interface (GUI) within at least part of the touch surface 4. The interface device 6 may be in the form of a substrate with a fixed image that is arranged over, under or within the panel 2. Alternatively, the interface device 6 may be a screen arranged underneath or inside the apparatus 1, or a projector arranged underneath or above the apparatus 1 to project an image onto the panel 2. Such an interface device 6 may provide a dynamic GUI, similar to the GUI provided by a computer screen. The interface device 6 is controlled by a GUI controller 28 that can determine where graphical objects of the GUI shall be located, for example by using coordinates corresponding to the coordinates for describing the interaction A1. The GUI controller 28 can be connected to and/or be implemented in the processor unit 26.

It should be noted that there are numerous other ways for coupling light into and coupling light out from the panel 2 that just as well might be used. This includes the possibility to couple the light into and out of the panel 2 directly via any of the sides 21-24. Alternatively, a separate coupling element may be attached to the sides 21-24, to the touch surface 4 or to the opposite surface 5 of the panel 2 to lead the light into or out of the panel 2. Such a coupling element may have the shape of e.g. a wedge. Also, the incoupling site may be only a small point at an edge or corner of the panel 2, and depending on the specific in/outcoupling technique used, the light may be propagated in the panel 2 as substantially straight beams, as diverging/converging/collimated beams, as coded beams using multiplexing etc. Moreover, the incoupling sites and the outcoupling sites may be arranged on common sides of the panel 2, depending on the specific in- outcoupling technique employed.

Hence, a number of alterative techniques exist for outputting data indicative of a distribution of light at an outcoupling site and which can be used with the method described below. For purpose of exemplifying such other techniques, patent documents U.S. Pat. No. 4,254,333, U.S. Pat. No. 6,972,753, U.S. Pat. No. 7,432,893, US2006/0114237, US2007/0075648, WO2009/048365, WO2010/006882, WO2010/006883, WO2010/006884, WO2010/006885, WO2010/006886 and International application No. PCT/SE2010/000135 are incorporated by reference, which documents describe various kinds of suitable incoupling and outcoupling of light as well as operations for obtaining one or more signals that are indicative of the spatial distribution of light in a light transmissive panel, and specifically signals that represent the light received at different spatial locations within one or more outcoupling sites.

Also, independent of the structure of the outcoupling site and/or incoupling site as well as independent of the exact configuration of the illumination and light detection arrangements, the illumination arrangement can operate in any suitable wavelength range, e.g. in the infrared or visible wavelength region. The light could be generated with identical wavelength as well as different for different emitters and detectors, permitting differentiation between emitters. Furthermore, the illumination arrangement can output either continuous or pulsed light.

The light can be generated by one or more light sources of the illumination arrangements 12x, 12y, which can be any type of device capable of emitting light in a desired wavelength range, for example a diode laser, a VCSEL (vertical-cavity surface-emitting laser), or alternatively an LED (light-emitting diode), an incandescent lamp, a halogen lamp, etc.

The light is detected by one or more photodetectors of the light detection arrangements 14x, 14y, and can be any sensor capable of measuring the energy of light emitted by the illumination arrangements 12x, 12y, which includes e.g. optical detectors, photoresistors, photovoltaic cells, photodiodes, reverse-biased LEDs acting as photodiodes, charge-coupled devices (CCD) etc.

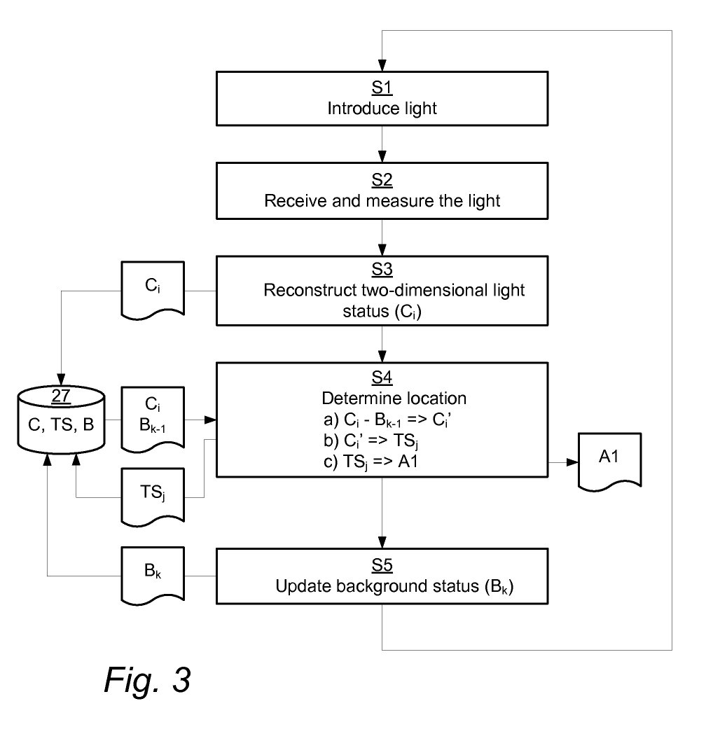

With reference to FIG. 3 a flow diagram of an embodiment of a method for determining the interaction A1 between the object 3 and the touch surface 4 is illustrated, making use of the following definitions:

Sᵢ-x and Sᵢ-y: the signal profiles derived from the energy of the light at an outcoupling site(s), such as the outcoupling sites 10y, 10x, during sensing instance no. i.

Cᵢ: the current light status which is a set of data describing the two-dimensional distribution of light in the panel 2 during sensing instance no. i.

Bₖ: the background status which is a set of data describing the two-dimensional distribution of light in the panel 2 caused by contaminations, i.e. by false interactions. The index k differentiates background statuses valid at different moments in time, and often the background status Bₖ is updated every sensing instance, even though less frequent updating of the background status Bₖ may be performed. The background status may be described by the same type of data as the current light status.

TSⱼ: the touch status which is a set of data describing the spatial distribution of a number of true objects currently present on the touch surface 4. By “true objects” are meant objects employed for user interaction with the panel 2, thereby causing “true touches” or “true interactions” like A1, as opposed to “false objects” in form of contaminations on the touch surface 2 causing “false touches” or “false interactions”. The index j differentiates touch statuses valid at different moments in time, and typically j=i. The touch status may also be referred to as an interaction status, or true interaction status.

Cᵢ′: a compensated light status defined by Cᵢ−Bₖ₋₁ or by a functional equivalent thereof, taking contaminations into account for the determining of true interactions like A1.

The processor unit 26 may be configured to determine the interaction A1 by repeatedly performing a number of steps S1-S5 which make use of the light (continuously or intermittently) introduced into the panel 2, propagated by internal reflection between the touch surface 4 and the opposite surface 5 and received by the light detection arrangement 14x, 14y. The method is iterative and the steps S1-S5 are carried out as long as the apparatus 1 is set in a mode for determining interactions, and typically sensing instance no. i corresponds to iteration no. i of the method.

In step S1 the light L is introduced into the panel 2 as described above.

In step S2 the introduced light is received as described above and data representing the energy of the light at the outcoupling sites 10x, 10y is obtained by the processor unit 26. As an example, the energy of the light at the outcoupling sites 10x, 10y can have a signal profile like the signal profiles Sᵢ-y and Sᵢ-x but may, depending on technology used for the in- and outcoupling of the light, have another signal profile(s) or data format for describing the spatial distribution of energy of light at the outcoupling site(s) at a given moment in time.

More particularly, the signal profiles Sᵢ-x and Sᵢ-y can be derived by normalizing a raw signal with a reference signal. The raw signal is typically the un-processed signal obtained by the light detection arrangements 14y, 14x and received at the processor unit 26 during user interaction with the apparatus 1. The reference signal is typically a signal obtained by the light detection arrangements 14y, 14x at a certain moment when no true interaction is present on the touch surface A1, such as when the assembly of the apparatus 1 is finalized or when a user initiates a reset operation of the apparatus 1. The reference signal is available to the processor unit 26, for example by storing it in the memory unit 27.

If the signal profiles Sᵢ-x and Sᵢ-y are set to the raw signal divided by the reference signal, the signal profiles Sᵢ-x and Sᵢ-y then typically represent the transmission T of light across the panel and will have signal profiles as illustrated in FIG. 1. On the other hand, if the signal profiles Sᵢ-x and Sᵢ-y shall represent the attenuation they may be calculated as one subtracted with the transmission (1−T). Moreover, the signal profiles Sᵢ-x and Sᵢ-y may be set to the raw signal without using any normalization.

More advanced techniques may be used for determining the signal profiles Sᵢ-x and Sᵢ-y, which can include updating the reference signal. For purpose of exemplifying such other techniques, International patent application No. PCT/SE2010/050932, filed on Sep. 1, 2010, is incorporated by reference, which document describes a “current signal profile”, a “background signal profile” and a “current compensated signal profile”. When used in context of the present application, the “current signal profile” can be applied as the above described raw signal, the “background signal profile” can be applied as above mentioned reference signal and the “current compensated signal profile” can be applied as the above mentioned signal profiles Sᵢ-x and Sᵢ-y.

In step S3, the processor unit 26 uses the data obtained in step S2 representing the energy of the light at the outcoupling sites 10x, 10y for reconstructing (i.e. determining) the current light status Cᵢ. Depending on the data format of the signal profiles Sᵢ-x and Sᵢ-y and/or depending on the reconstruction method used, the current light status Cᵢ can be a set of data describing the two-dimensional distribution of i) the attenuation, ii) the general transmission of light, iii) the intensity of light or any other parameter related to the two-dimensional distribution of light in the panel 2. In any case, both contaminations and true interactions are included in the current light status Cᵢ since the current light status Cᵢ is obtained by the currently measured light during the current iteration/sensing instance (hence the denotation “current”). Accordingly, the current light status Cᵢ holds information about both true interactions and false interactions.

A reconstruction algorithm is generally employed using the data obtained in step S2 as input for generating the current light status Cᵢ. As is known within the art, generating a two-dimensional distribution of light per se, i.e. reconstructing a two-dimensional distribution of light like the current light status Cᵢ, can be done in numerous ways and hence any suitable technique may be used. However, often the reconstruction of the current light status Cᵢ typically involves generating a spatial distribution map, which indicates the spatial distribution of e.g. energy/attenuation/general transmission values within an analysis area of the panel 2 corresponding to, for example, the area of the touch surface 4. The spatial distribution map may comprise a number of pixels (points or picture elements) which can be a certain (generally the smallest) item of information in the distribution map. Typically the pixels are arranged in a 2-dimensional grid, and can be represented as e.g. dots or squares.

For example, a standard tomography method such as filtered back projection may be adapted for reconstruction within the analysis area(s). The theory of tomographic reconstruction is well-known in the art, and is thoroughly described in text books such as “Mathematical Methods in Image Reconstruction” by Frank Natterer and Frank Wubbeling, and “Principles of Computerized Tomographic Imaging” by Kak and Slaney.

For a thorough description of the filtered back projection algorithm, as well as the differences in implementation between setups using different light-incoupling/outcoupling techniques, reference is made to the text books mentioned above. Here, only a rough outline of the major steps in the algorithm is given, as adapted for the reconstruction.

The filtered back projection algorithm generally operates on so-called projections, which may correspond to the above-mentioned signal profiles Sᵢ-x and Sᵢ-y. As applied for reconstruction of the complete touch surface 4, the algorithm would operate to, for each projection:

a) Apply a suitable filter to the projection. Suitable filters are found in the literature, but can for instance be Ram-Lak or Shepp-Logan. The filter can be applied either in the Fourier plane or in the spatial domain.

b) For each of a number of pixels in the spatial distribution map, compute a reconstructed signal value as the sum of the pixel's interaction with all the filtered projections (the back projection process).

It should be emphasized that the reconstruction of the current light status C, is not limited to the use of the filtered back projection algorithm. In essence any existing image reconstruction technique may be used, including but not limited to CT (Computed Tomography), ART (Algebraic Reconstruction Technique), SIRT (Simultaneous Iterative Reconstruction Technique), SART (Algebraic Reconstruction Technique), Direct 2D FFT (Two-Dimensional Fast Fourier Transform) reconstruction, or a statistical reconstruction method, such as Bayesian inversion. Embodiments of a techniques for image reconstruction are further disclosed in Applicant's U.S. provisional applications No. 61/272667, filed on Oct. 19, 2009 and No. 61/282973, filed on May 3, 2010, which are incorporated herein by reference.

A general advantage of the reconstruction lies in a possibility to, in a subsequent touch identification step S4, use the reconstructed two-dimensional light distribution Cᵢ to reliably distinguish between true and false interactions on the touch surface 4.

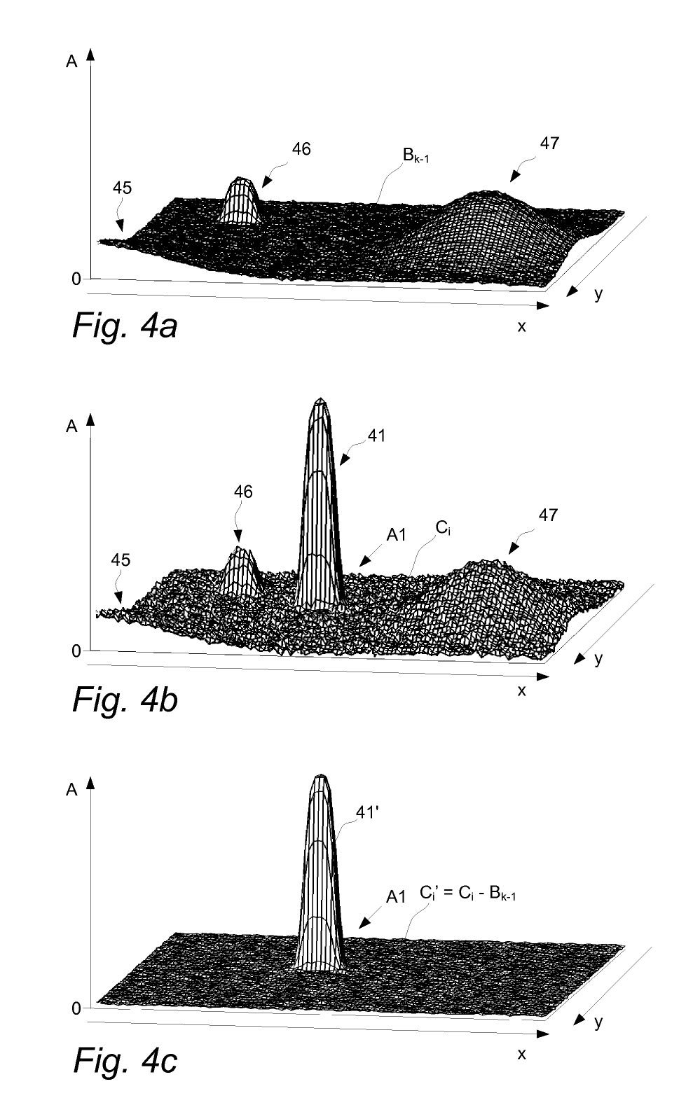

For exemplifying a spatial distribution map, reference is made to FIG. 4a, which shows the two-dimensional distribution of the attenuation of a background status Bₖ₋₁, where the attenuation (A) is plotted as a function of its distribution along the x-axis and y-axis of the panel coordinate system. The plotted background status Bₖ₋₁ was updated in a previous iteration of the method as indicated by the index k−1, in a manner that will be described below.

Since the background status Bₖ₋₁ of FIG. 4a shows attenuation, signal profiles Sᵢ-x and Sᵢ-y used for reconstructing the background status Bₖ₋₁ can typically represent the attenuation in the panel 2, even though the signal profiles Sᵢ-x and Sᵢ-y are illustrated as transmission profiles in FIG. 1. Also, other forms of signal profiles Sᵢ-x and Sᵢ-y are feasible, in particular if normalizing operations are included in step S3.

In further detail, the spatial distribution map of FIG. 4a is plotted in the form of a 3-D graph where, since the graph illustrates attenuation, a higher (increased) value represents a lower (decreased) intensity of light in the panel 2. Thus, a decreased intensity of light given by a decrease in the signal profiles Sᵢ-x and/or Sᵢ-y corresponds to an increase in the exemplified spatial distribution map of FIG. 4a.

Since the exemplified distribution map illustrates the background status Bₖ₋₁ in form of attenuation, any increase of signal levels are hence due to contaminations on the touch surface 4. Examples of contaminations include dust collected at a corner of the touch surface resulting in a first section 45 of increased signal level, a fingerprint resulting in a second section 46 of increased signal level and spilled fluid resulting in a third section 47 of increased signal level. Other sections of the background status Bₖ₋₁ outside sections 45-47 have an essentially uniform attenuation level, typically caused by imperfections evenly distributed in the panel and by various signal noise.

For describing another example of a spatial distribution map, reference is made to FIG. 4b which shows the current light status Cᵢ in form of a two-dimensional distribution of the current attenuation (A), which is plotted in a manner corresponding to FIG. 4a. The current light status Cᵢ is determined on basis of the two-dimensional distribution of the attenuation caused by any contaminations and any touch objects currently present on the touch surface 4, and hence displays the same sections 45-47 of increased signal levels as the background status Bₖ₋₁ of FIG. 4a. However, the current light status Cᵢ also displays a section 41 of a sharp increase in attenuation caused by the interaction A1 between the touch surface 4 and the true object 3. Since the section 41 is caused by the interaction A1, the interaction A1 can be seen as located at the base of the section 41.

Returning now to FIG. 3, in step S4 one or more interactions like the interaction A1 can be determined on basis of the current light status Cᵢ obtained during the current iteration and the background status Bₖ₋₁ obtained during a previous iteration. Typically, the background status Bₖ₋₁ can be retrieved from any suitable data storage of the apparatus 1 such as from the memory unit 27, or can be temporarily stored as a variable used in a software program executing the method. Of course, the current light status Cᵢ and the touch status TSⱼ may also be stored in the memory unit 27, as temporary variables in an executing software program or in any other suitable form.

The current light status Cᵢ and the previous background status Bₖ₋₁ are first used for determining the compensated light status Cᵢ′, where Cᵢ′=Cᵢ−Bₖ₋₁. Accordingly, when determining the compensated light status Cᵢ′ contaminations are taken into account, and the compensated light status Cᵢ′ can be plotted as a function of its distribution along the x-axis and y-axis of the panel coordinate system, i.e. the two-dimensional distribution of the compensated light status Cᵢ′ is given.

The resulting compensated light status Cᵢ′ and its two-dimensional distribution is illustrated by FIG. 4c. As can be seen the compensated light status Cᵢ′ has a section 41′ of increased signal level which indicates the interaction A1 and which spatially corresponds to the section 41 of increased signal level of the current light status Cᵢ. The compensated light status Cᵢ′ has an essentially uniform signal level at a compensated light status Cᵢ′ of about zero but for sections indicating differences between the status levels (attenuation) of the current light status Cᵢ and the background status Bₖ₋₁. This greatly facilitates the identification of relevant sections indicative of true interactions.

Alternatively, the compensated light status Cᵢ′ may be calculated on basis on a relative difference between the current light status Cᵢ and the previous background status Bₖ₋₁, e.g. by using the function Cᵢ′=Cᵢ/ Bₖ₋₁, or by using the function log (Cᵢ′)=log(Cᵢ)−log (Bₖ₋₁). When calculating the compensated light status Cᵢ′ in this manner each pixel of Bₖ₋₁ should preferably never attain a value that is close to zero.

Moreover, instead of presenting the current light status Cᵢ and background status Bₖ₋₁ in the form of attenuation, where a touch or contamination causes increased attenuation values, the presentation may be in the form of an energy level of the light, where a touch or contamination causes decreased energy values. In this case, when the current light status and background status indicate true and false interactions by decreased signal levels, a compensated light status based on e.g. dividing the current light status with the background status gives the so called transmission, which in turn indicates any true interaction as a decrease in (transmission) signal level. However, the transmission, or more specifically a relative change of transmission Tᵢ, may be determined even though the current light status Cᵢ and the previous background status Bₖ₋₁ represent attenuation, for example by using the expression Tᵢ=(1−Cᵢ)/(1−Bₖ₋₁).

When the compensated light status Cᵢ′ has been determined, true interactions like A1 may be derived therefrom, optionally also on the basis of compensated light statuses calculated during previous iterations.

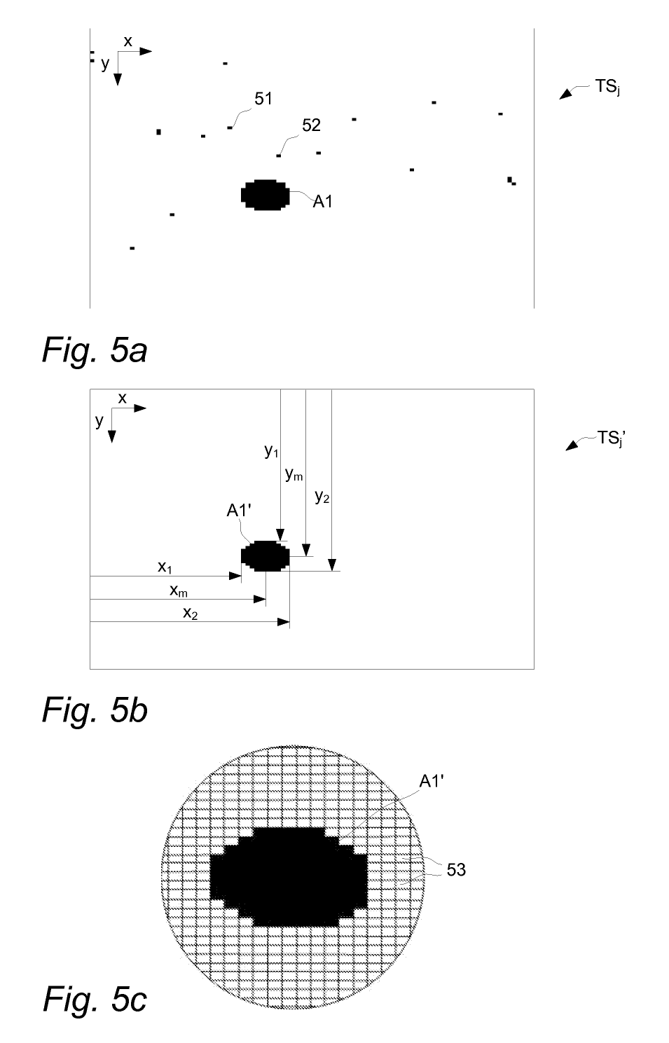

For this purpose and with further reference to FIG. 5a, the so called touch status TSⱼ is determined for deriving the true interactions. The touch status TSⱼ is in this embodiment a spatial distribution map that comprises image pixels spatially corresponding to the image pixels of the distribution maps of FIGS. 4a-4c.

Each pixel of the touch status TSⱼ can indicate if the pixel is included in the interaction, typically on the basis of the signal level at the corresponding pixel of the compensated light status Cᵢ′. For example, a pixel of the touch status TSⱼ may indicate (part of) an interaction when e.g. the magnitude of the signal level of the corresponding current light status pixel is above/below a certain level. A pixel of the touch status TSⱼ that indicates an interaction typically has an “interaction state” set while a pixel not indicating any interaction has not the “interaction state” set.

It should be noted that other alternatives for setting the touch status TSⱼ can be used. For example, interaction state may be set for all pixels where i) Cᵢ>Bₖ₋₁, ii) Cᵢ−Bₖ₋₁>0, iii) Cᵢ>Bₖ₋₁+threshold value, iv) Cᵢ−Bₖ₋₁>threshold value etc. The comparing relation between Cᵢ and Bₖ₋₁ may also be reversed, for example if Cᵢ and Bₖ₋₁ represent a current transmission and a background transmission.

Each pixel of the compensated light status Cᵢ′ is processed to determine if the interaction state of the corresponding pixel of the touch status TSⱼ is to be set. During this process some pixels of the touch status TSⱼ not corresponding to the interaction A1 may erroneously be set in the interaction state, such as the pixels 51 and 52 in FIG. 5a, which typically occurs due to noise in the compensated light status Cᵢ′. For correcting such pixels, a spatial filter can be applied on the touch status TSⱼ. For instance, a pixel can be denied having the interaction state set unless a number of adjacent pixels also are, or will be, set in the interaction state.

For the filtering, a morphological algorithm may advantageously be used to remove any interaction state that does not correctly correspond to an interaction. This can for instance involve a combination of the known morphological operations of erosion, dilation, open and close. When employed on the exemplified touch status TSⱼ, binary morphology will usually suffice, which is based on probing the touch status TSⱼ with a pre-defined shape in form of a structuring element that concludes how this shape fits or misses the shapes in the touch status TSⱼ.

With further reference to FIGS. 5b and 5c, when the touch status TSⱼ is filtered, a filtered touch status TSⱼ′ is generated where erroneously set pixels are corrected, as can be seen in the figures. The filtered touch status TSⱼ′ generally comprises pixels corresponding to the pixels of the un-filtered touch status TSⱼ. Moreover, the interaction A1 is typically adjusted to a filtered interaction A1′, which is illustrated in larger detail in FIG. 5c where also individual pixels 53 of the filtered touch status can be seen.

Once the filtered touch status TSⱼ′ is determined each true interaction is also determined, as the filtered touch status TSⱼ′ per se indicates each true interaction. For example, if the extent of an interaction is to be determined, the x-coordinates x₁, x₂ of boundary pixels of the interaction A1 together with corresponding y-coordinates y₁, y₂ can be outputted. If the location of the interaction is to be determined, a mean x-coordinate xₘ representing the average x-coordinate of each pixel indicating the interaction A1, and a mean y-coordinate yₘ representing the average y-coordinate of each pixel indicating the interaction A1 can be outputted.

As an alternative or complement for filtering of the touch status TSⱼ, a segmentation algorithm such as blob detection or a clustering algorithm can be used. The filtering of pixels can also use various versions of the Watershed or K-means algorithms. It is also possible to track the position of interactions (i.e. pixel clusters with a set interaction state) and to predict where an interaction is to be centered in a subsequent iteration. This information can also stabilize the setting of interaction states for the pixels. For instance, if a moving interaction has been detected, i.e. a drag over the touch surface, it can be expected that residues will be left behind the drag. It is then possible to e.g. set all the pixels that the drag leaves into a non-set interaction state.

It should be noted that it is not necessary to use the touch status TSⱼ for determining the interaction A1 and outputting various panel coordinates describing the interaction A1. Instead or as a complement, the interaction A1 can be determined on basis of a change in the compensated light status Cᵢ′ over a number of sensing instances. It is also possible to determine an interaction (or setting interaction states) based on a signal level at one or more pixels of the compensated light status Cᵢ′, where a sufficiently large signal level for a certain number of pixels can indicate the interaction. For example, mean coordinates of the interaction A1 may be determined on basis of an average position of interaction-indicating pixels in the spatial distribution map of the compensated light status Cᵢ′, where the position of each pixel then may be weighted by its corresponding attenuation value. Exactly which amount of signal level and/or the exact number of pixels that are to be used for indicating a true interaction may be empirically determined.

Also, the magnitude of a volume of increased signal level, such as the volume of the interaction indicating section 41′ in FIG. 4c may indicate the interaction A1. Furthermore, priori knowledge about the interactions, for example by using information about the location of interactions that were identified during preceding sensing instances, can be used for increasing the accuracy and/or computation speed of the determination of interactions.

Referring to FIG. 3, in step S5, when the touch status TSⱼ has been determined, the background status Bₖ₋₁ is updated so as to generate an updated background status Bₖ, which can include a number of operations as described below, either in combination or alone. Generally, the background status Bₖ₋₁ can be updated pixel-by-pixel on basis of values or settings of spatially corresponding pixels of previous background statuses, current light statuses, previous light statuses and/or touch statuses. Often pixels of the background status Bₖ₋₁ that correspond or corresponded to an interaction are updated different from pixels that do not correspond to any current interaction. The background status can also be updated on a section-by-section basis, where each section comprises a number of pixels.

Typically, the background status Bₖ₋₁ is updated by setting the updated background status Bₖ equal to the current light status Cᵢ when no object touches the touch surface, i.e. when no interaction was present during the previous iteration. Also, setting Bₖ equal to Cᵢ may be done in a calibration procedure during the manufacturing of the touch apparatus for defining a very first background status. The background status Bₖ can also be set to the current light status Cᵢ in response to a user initialization, for example as part of a reset-operation when a user is able to verify that no true object interacts with the touch surface.

Another way of updating the background status Bₖ₋₁ includes computing each pixel of the background status as the average current light status measured over time for the relevant pixel. In this case the current light status is measured at regular time intervals and the mean value, which often changes over the time as more contaminants are added to the panel, is calculated from the measured spatial distribution.

Also, a so called window function can be used where each pixel of the updated background status Bₖ is computed as the average current light status within a certain time interval for the relevant pixel, for example as the average current light status measured within an interval from a current time to 10 seconds back in time.

An additional operation includes updating the background status as a function of the current light status Cᵢ and a previously updated background status, for example by weighting the current light status Cᵢ relatively lower than the previously updated background status. An example of this is illustrated by the following formula:

Bₖ=(1−ε)·Bₖ₋₁+ε·Cᵢ (1)

where 0<=ε<1. By selecting a lower value of ε, the current light status Cᵢ is given a relatively lower weight, which can e.g. reduce the effect of momentary disturbances since not all of the updated background status then depends on the very latest measurement signal(s). By selecting a higher value of ε, it is possible to achieve a faster update of the background profile, which can be particularly relevant if it has been detected that an interaction has disappeared. The background can here be updated pixel-by-pixel or for groups of pixels.

Another updating operation for the background status Bₖ₋₁ includes updating a section (group of pixels) of the background status Bₖ₋₁ that spatially corresponds to the interaction A1 in a different way than sections (groups of pixels) of the background status Bₖ₋₁ that do not indicate any interaction, which can be done as long as the interaction A1 is present. Determining which section of the background status that corresponds to an interaction or not can be done by correlating the interaction-indicating pixels of the filtered touch status TSⱼ′ with spatially corresponding pixels of the background status.

An additional operation for updating the background status Bₖ₋₁ includes updating, when an interaction is removed from the touch surface, the section of the background status that spatially corresponds to the removed interaction faster than other sections of the background status. The faster updating is performed for a certain period of time from when the interaction was removed, i.e. as soon as a true touch disappears from the panel the section of the background status spatially corresponding to the true touch is updated at a faster rate than other sections of the background status. For example, when an interaction is removed, the associated section of the background status can be updated every sensing instance for 40 subsequent sensing instances, while other sections of the background status that are unaffected by the removed interaction are updated every fifth sensing instance. By performing this operation, any contamination resulting from e.g. a fingerprint remaining on the location of the previous interaction can be taken into account relatively fast. Moreover, in cases when the background status is updated every iteration it is possible to achieve the faster update by changing the temporal behavior of the update procedure, which can be achieved by e.g. increasing the value of ε in formula (1).

It is also possible to update a section of the background status different if that section spatially corresponds to a specific object of the GUI, such as a pictogram in the form of e.g. a computer icon.

A further updating operation includes updating the background status as a function of time. For example, the background status may be set to a current light status obtained at least 4 seconds back in time. Such an operation is practical if the background status is distorted by events that cannot be detected until after several sensing instances.

The updating of the background status can also be implemented as an integrated control system using the current light status Cᵢ and a previous background status as input. An example of such a control system can mathematically be described by the following formula where, for example, k=i, a is a time coefficient typically between 0.001 to 0.1 and where Bₓ is typically set to a value of the background status between 1 and 50 sensing instances before entering an interaction state:

$${B}_{k} = \{ \begin{matrix}{B}_{k - 1} + a \cdot ( {C}_{i} - {B}_{k - 1} ) , & for pixels of {B}_{k - 1} ∉ interaction state \\ {B}_{k - 1} + a \cdot ( {B}_{x} - {B}_{k - 1} ) , & for pixels of {B}_{k - 1} ∈ interaction state\end{matrix} \qquad ( 2 )$$

The updating is typically done on pixel-by-pixel basis, and Bₓ is generally not updated after the interaction state has been entered but it is a measure of how the background was before the interaction state was entered.

Here, the “interaction state” refers to a section of the background status that spatially corresponds to an interaction. Also, immediately after a touch has appeared or disappeared, coefficient a is generally set to a higher value, typically in the range from 0.01 to 1.0 in order to quickly adapt to a previous Bₓ-value or a new Cᵢ-value.

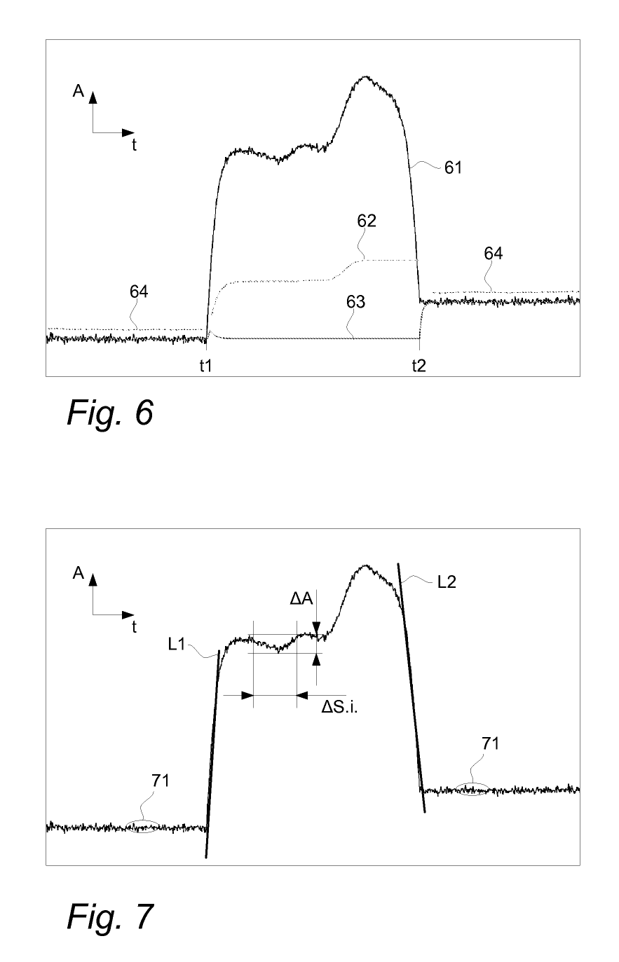

For illustrating how the background status Bₖ may be updated, reference is made to FIG. 6 where a first curve 61 shows time-distributed attenuation of the current light status Cᵢ at a certain pixel or set of pixels and where a second curve 63 show time distributed attenuation of the background status at the same pixel(s). Accordingly, attenuation A is here plotted as a function of time t.

As can be seen, the current light status 61 and the background status 63 have roughly same attenuation values in the beginning. At this point, any small difference in attenuation values may typically be caused by the background status 63 being low-pass filtered while the current light status 61 is not.

At a certain point t1 in time the current light status increases sharply which typically corresponds to an interaction with a true object at the location of the certain pixel(s). Assuming the background status is updated with a method that uses the current light status, the background status increases at the very same point t1 in time. However, since the current light status 61 increases above a certain level illustrated by curve 64, it can be determined that a true interaction is present and the increase of the background status can be remedied by setting the background status to a value that the background status had at a moment prior the point t1 in time. A threshold level illustrated by curve 62 can then be used for determining when the interaction is no longer present, i.e. when the current light status 61 falls below the threshold level 62 at point t2 in time, it can be determined that the interaction is no longer present. The threshold level 62 can be set to e.g. 30% of the maximum-value measured so far for the current light status a number of iterations back in time.

As long as the interaction is present, the background status 63 is not updated, but as soon as the interaction disappears at time t2 the background status 63 is updated by taking a current light status into account, such that the background status then has essentially the same signal level as the current light status. The increased signal levels (attenuation) after the time t2 in comparison with the signal level prior the time t1 are typically caused by a false interaction in form of a fingerprint remaining on the location of the previous true interaction.

As indicated in FIG. 6, after the time t2 the certain level 64 for defining the threshold value for an appearing interaction is increased by the same increase as was determined for the background status.

As mentioned above, the updating of the background status can be performed in dependence of an interaction caused by a true object. Some alternatives for determining if such an object is present on the touch surface includes i) successfully determining an interaction during a previous iteration, ii) determining a quick temporal change of a current light status Cᵢ and iii) determining a time-distributed ripple of the current light status Cᵢ.

For illustrating the two latter alternatives ii) and iii) reference is made to FIG. 7 which shows time-distributed attenuation of the current light status Cᵢ at a certain pixel or set of pixels. The determining of a quick temporal change of a current light status Cᵢ is sometimes referred to as slope detection and includes measuring the change of a part of the time-distributed attenuation. If the change increases sharply it is considered to indicate an interaction. In a similar manner, if the attenuation decreases sharply between sensing instances, it can be determined that an interaction has disappeared.

As can be seen in FIG. 7, there is a sharp increase of the attenuation within a short period of time, as indicated by line L1, and a sharp decrease of the attenuation, as indicated by L2. The amount of the increase/decrease of the attenuation generally depends on the attenuation properties of the touching object, on how hard the object is pressed on the panel and on the specific hardware components and materials used in the apparatus. The amount of change may be empirically determined for every type of touch sensing apparatus, e.g. by measuring the magnitude when touching/not touching the touch surface with various kinds of commonly used objects.

Determining a time-distributed ripple of the signal profile may involve investigating those sections that indicate an increased attenuation of light due to an interaction. If the magnitude of the investigated section changes to a certain extent between sensing instances, i.e. if a ripple is present, the ripple is usually indicative of an interaction initiated by a person, which is based on the understanding that persons rarely are completely still. Exactly how much ripple is indicative of an interaction can be empirically determined.

An example of such a ripple is illustrated by FIG. 7 where a variation in attenuation ΔA over an interval of sensing instances ΔS.i can be seen. The exact variation in attenuation ΔA can be empirically determined but is in any case larger than a small, general ripple such as the ripple indicated by section 71 commonly resulting from signal noise in the apparatus.

The two latter alternatives ii) and iii) are not limited to the apparatus and method described herein, and since both alternatives rely on the time distribution of light at a section on the touch surface for identifying presence and/or a location of an interaction, a general method applicable in connection with other touch-sensitive apparatuses comprises determining a presence and/or a location of an interaction as a function of the time distributed variation of light received at an outcoupling site. The alternatives ii) and iii) are more detailed embodiments of the general method and can be used in combination.

Hence, instead of using a current light status for the determining according to alternatives ii) and iii), any other data indicating time distributed distribution of light in the panel may be used, such as the compensated distribution of light or a raw signal of the light detectors or any signal derived there from

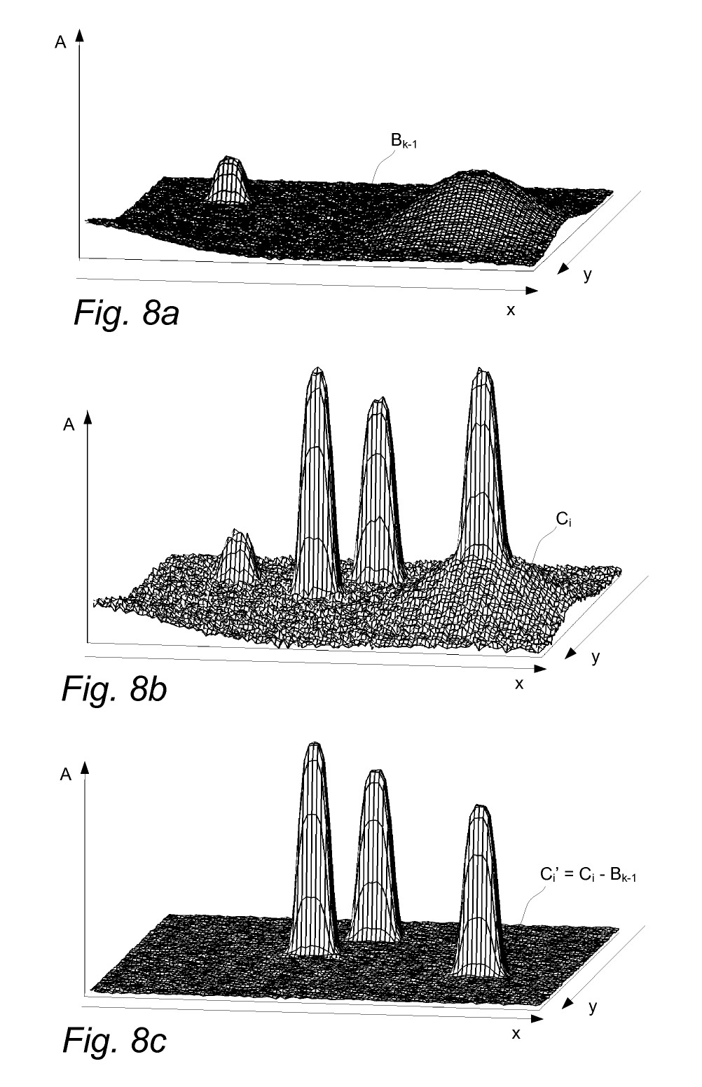

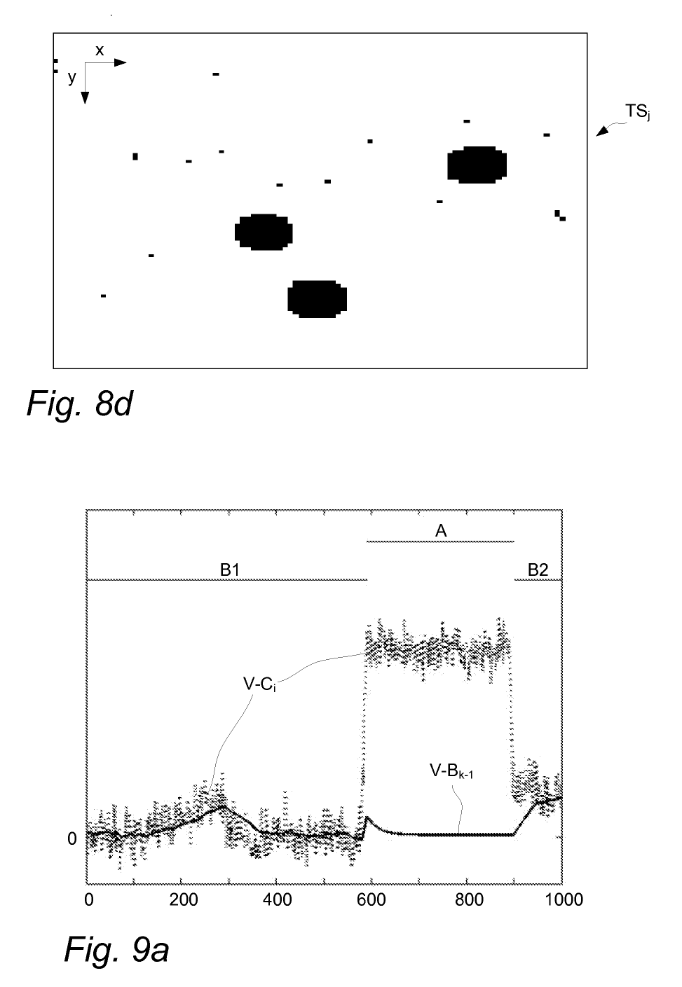

With further reference to FIGS. 8a-8d, background status Bₖ₋₁, current light status Cᵢ, compensated light status Cᵢ′ and touch status TSⱼ derived when multiple (three) interactions are present on the touch surface 4 are illustrated. As can be seen, the different statuses are more complex as more interactions are present. However, the various embodiments described herein require a relatively small computational effort when employed for determining multiple true interactions.

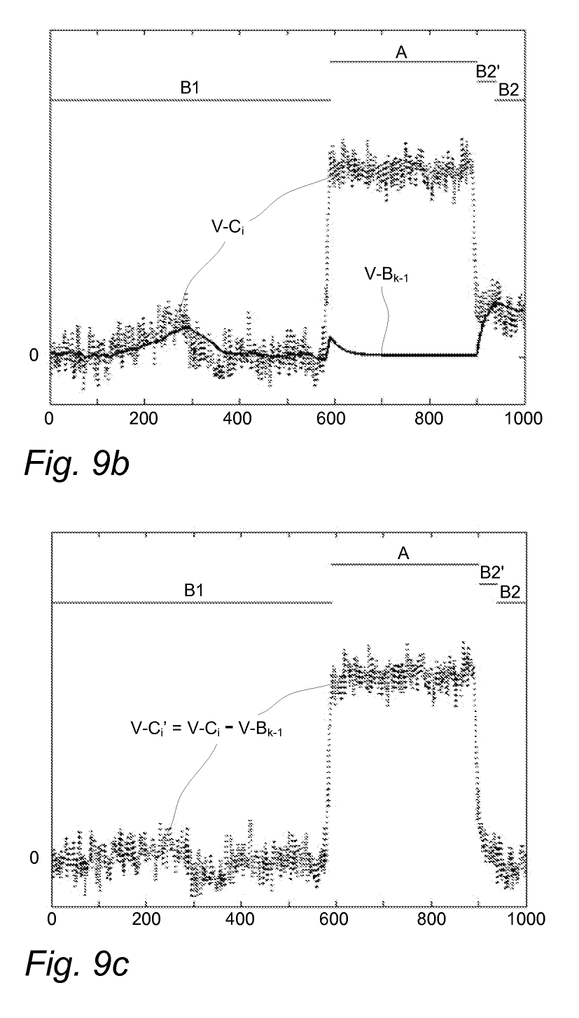

With reference to FIGS. 9a-c results of some calculations described above are illustrated in further detail. These figures illustrate two examples of how a background status Bₖ₋₁ can be updated as a function of the interaction.

FIG. 9a shows time distributed attenuation values V−Cᵢ of a current light status Cᵢ and time distributed attenuation values V−Bₖ₋₁ of a background status Bₖ₋₁, as determined over 1000 sensing instances at a certain pixel of set of pixels. The time distributed values of V−Cᵢ exhibit some noise, which can be seen by the variance in values covered by e.g. section B1. Values covered by section A indicate a touch by a finger, and values covered by section B2 have an increased attenuation in comparison with the values covered by section B1, which is the typical effect of a fingerprint caused by the touch of the finger. The time distributed values V−Bₖ₋₁ of the background status Bₖ₋₁ are updated as described above, which includes refraining from updating during the sensing instances covered by section A, except for a small reset performed directly after the touch has appeared.

FIG. 9b corresponds to FIG. 9a but with the difference of a faster update of the background status Bₖ₋₁ after the touch has disappeared. The faster update is performed for sensing instances covered by section B2′, while normal update is performed at sensing instances covered by section B2. As can be seen, after the touch has disappeared the values of V−Bₖ₋₁ reflect the values of V−Cᵢ faster than in FIG. 9a, which allows the effect of the fingerprint to be taken into account at an earlier stage.

FIG. 9c exemplifies time distributed attenuation values V−Cᵢ′ of a compensated light status Cᵢ′. Here, V−Cᵢ′=V−Cᵢ−V−Bₖ₋₁, and V−Cᵢ respectively V−Bₖ₋₁ are the values shown in FIG. 9b. As can be seen, the time distributed values V−Cᵢ′ covered by sections B2 and B2′ basically correspond to the values covered by section B1, even though a fingerprint is present for sensing instances covered by sections B2 and B2′. However, the values covered by sections B2 and B2′ would have been significantly higher if the background status was not updated as described.

Software instructions, i.e. a computer program code for carrying out embodiments of the described method may for development convenience be written in a high-level programming language such as Java, C, and/or C++ but also in other programming languages, such as, but not limited to, interpreted languages. The software instructions can also be written in assembly language or even micro-code to enhance performance and/or memory usage. It will be further appreciated that the functionality of any or all of the functional steps performed by the apparatus may also be implemented using discrete hardware components, one or more application specific integrated circuits, or a programmed digital signal processor or microcontroller. Accordingly, the computer-readable medium 27 can store processing (software) instructions that, when executed by the processor unit 26, performs the method implemented in the apparatus 1.

The apparatus may also handle situations where contaminations are removed from the touch surface, which typically results in a decreased attenuation at the location of the removed contamination. In this case the updating of the background status can be seen as “negative” in comparison with the situation when contamination is added to the touch surface.

As indicated above, the use of the touch status may be omitted such that one or more interactions are derived directly from the compensated light status. Such a variant is particularly plausible whenever attenuation due to contaminations is relatively small. For example, true interactions may be distinguished from interactions among the compensated light status based on the shape and/or size of the spatial distribution map, provided the shape and/or size can be compared with known values of shape and/or size corresponding to interactions or contaminations.

As indicated, the processor unit performs an iterative (repetitive) operation for determining the interaction of the object touching the touch surface. Moreover, the iteration can be continuously performed irrespectively if the object interacts with the touch surface. Also, operations of the processor unit may be performed in a different order than described, may be combined and may be divided into sub-operations. Furthermore, additional operations may be performed by the processor unit and certain operations can be performed only when the processor unit determines that an object interacts with the touch surface. Also, as the skilled person realizes, the processor unit can comprise one or more data processors which each performs one or more of the described processing operations.

1. An apparatus for determining an interaction between an object and a touch surface, the apparatus comprising:
a light transmissive panel defining the touch surface and an opposite surface,
an illumination arrangement configured to introduce light into the panel for propagation by internal reflection between the touch surface and the opposite surface
a light detection arrangement configured to receive the light propagating in the panel, and
a processor unit configured to iteratively
determine, based on the received light, a current light status representing a current two-dimensional distribution of light in the panel,
determine, when the object touches the touch surface and thereby attenuates the light propagating in the panel, the interaction as a function of the current light status and a previously updated background status representing a two-dimensional distribution of light in the panel caused by contaminations, and
update the background status as a function of the interaction.

2. An apparatus according to claim 1, wherein the processor unit is configured to update the background status when the object is present on the touch surface.

3. An apparatus according to claim 1, wherein the processor unit is configured to update a first section of the background status corresponding to the interaction different from a second section of the background status not corresponding to the interaction.

4. An apparatus according to claim 1, wherein the processor unit is configured to refrain from updating a first section of the background status corresponding to the interaction while updating a second section of the background status not corresponding to the interaction.

5. An apparatus according to claim 1, wherein the processor unit is configured to update a first section of the background status corresponding to the interaction by setting a value of the first section as a function of a value of a spatially corresponding section of a previous background status.

6. An apparatus according to claim 1, wherein the processor unit is configured to update a first section of the background status corresponding to the interaction faster than a second section of the background status not corresponding to the interaction, when the interaction between the object and the touch surface has disappeared.

7. An apparatus according to claim 1, wherein the processor unit is configured to update the background status at predetermined time intervals that are established as a function of interactions with the touch surface.

8. An apparatus according to claim 1, wherein the processor unit is configured to reconstruct the current light status and the background status on basis of light received by the light detection arrangement.

9. An apparatus according to claim 1, wherein the processor unit configured to determine, when the object touches the touch surface and thereby attenuates the light propagating in the panel, the interaction in dependence of a time-distributed variation of light received by the light detection arrangement.

10. An apparatus according to claim 1, wherein the processor unit is configured to determine, when the object touches the touch surface and thereby attenuates the light propagating in the panel, the interaction in dependence of a time passed since the interaction was determined.

11. An apparatus according to claim 1, wherein the processor unit is configured to determine a touch status of the panel, where the touch status defines the spatial distribution of a number of objects currently present on the touch surface.

12. An apparatus according to claim 11, wherein the processor unit is configured to update the background status as a function of the touch status.

13. An apparatus according to claim 11, wherein the touch status comprises data elements, each data element corresponding to a respective image pixel of the touch surface.

14. An apparatus according to claim 13, wherein the data elements are configured to indicate the interaction between the object and the touch surface.

15. An apparatus according to claim 13, wherein the processor unit is configured to morphologically filter the data elements.

16. An apparatus according to claim 1, wherein the processor unit is configured to compare a value of the background status with a value of the current light status, when determining the interaction.

17. An apparatus according to claims 1, wherein the processor unit is configured to divide a value of the current light status with a value of the background status, when determining the interaction.

18. An apparatus according to claim 1, wherein the processor unit is configured to subtract a logarithm of a value of the background status from a logarithm of a value of the current light status, when determining the interaction.

19. An apparatus according to claim 1, wherein the illumination arrangement comprises a set of light emitters for introducing the light and the light detection arrangement comprises a set of light detectors for receiving the light, the current two-dimensional distribution of light represented by the current light status and the two-dimensional distribution of light caused by contaminations and represented by the updated background status each being introduced and received by the same sets of light emitters and light detectors.

20. (canceled)

21. A method for determining an interaction between an object and a touch surface of a light transmissive panel defining the touch surface and an opposite surface, the method comprising the steps of iteratively:
determining, based on light received by a light detection arrangement after propagation in the light transmissive panel by internal reflection between the touch surface and the opposite surface, a current light status representing a current two-dimensional distribution of light in the panel,
determining, when the object has touched the touch surface and thereby attenuated the light propagated in the panel, the interaction as a function of the current light status and a previously updated background status representing a two-dimensional distribution of light in the panel caused by contaminations, and
updating the background status as a function of the interaction.

22. A computer-readable medium storing processing instructions that, when executed by a processor, performs the method according to claim 20.
